(19) United States
(12) Patent Application Publication
(10) Pub. No.: US 2026/0017595 A1
(43) Pub. Date: Jan. 15, 2026

(54) ANALYSIS SYSTEM AND ANALYSIS METHOD

(71) Applicant: Mitsubishi Electric Corporation, Tokyo (JP)

(72) Inventors: Kenta FUJIMOTO, Tokyo (JP); Kohei FUJITA, Tokyo (JP); Satoshi IWATSU, Tokyo (JP); Hirofumi KAI, Tokyo (JP)

(73) Assignee: Mitsubishi Electric Corporation, Tokyo (JP)

(21) Appl. No.: 18/881,881

(22) PCT Filed: Jul. 19, 2022
(86) PCT No.: PCT/JP2022/028016

§ 371 Date: Jan. 7, 2025

(51) Int. Cl. G06Q 10/0639; G06Q 30/018

(52) U.S. Cl. CPC G06Q 10/06395; G06Q 30/018

(57) ABSTRACT

To cause an operator to easily identify a plant and work where an emission amount is large. An analysis system includes a measuring unit that measures a consumption/emission amount in a step, and an analysis unit that extracts the step corresponding to the consumption/emission amount that is equal to or greater than a first threshold by analyzing a plurality of the consumption/emission amounts. Information determining the configuration of data to be measured or a method of measuring the data in a changeable manner is defined as a profile. The measuring unit sets a measurement unit of the consumption/emission amount or a method of measuring the consumption/emission amount on the basis of the profile.

### TECHNICAL FIELD

A technique disclosed in the present description relates to an analysis technique.

### BACKGROUND ART

In order to make a follow-up study efficiently on a cause having increased the amount of emitted greenhouse gas (such as carbon dioxide), a conventional greenhouse gas emission amount control device outputs information with respect to each lot that is unique to an emission amount in a raw material, utility, or the like (see Patent Document 1, for example).

### PRIOR ART DOCUMENT

### Patent Document

Patent Document 1: Japanese Patent Application Laid-Open No. 2012-247954

### SUMMARY

### Problem to Be Solved by the Invention

According to the above-described technique, a carbon dioxide emission amount is presented with respect to each step of a target product or each cause, thereby identifying a step having caused a deviation in carbon dioxide emission amount. Then, a raw material and utility having caused the deviation are identified. This makes it possible to determine temporal change in utility on the basis of standard data or plant efficiency of a utility plant, determine a carbon dioxide emission amount per unit of a raw material input, or determine a carbon dioxide emission amount per unit of utility usage on the basis of standard data.

Such a greenhouse gas emission amount control device handles an enormous quantity of information about every plant on the basis of standard data. This imposes difficulty in identifying a plant and work where an emission amount such as that of carbon dioxide is large.

A technique disclosed in the present description has been made to solve the above-described problems, and is a technique for facilitating identification of a plant and work of a large emission amount.

### Means to Solve the Problem

An analysis system according to a first aspect of a technique disclosed in the present description includes: at least one measuring unit that measures each of the amount of consumed energy and the amount of emitted drainage or exhausted air as a consumption/emission amount in a plurality of steps including procurement of a part to form a target product, manufacture of the target product using the part, carriage of the target product, and selling of the target product; at least one notifying unit that notifies a plurality of the consumption/emission amounts measured by the measuring unit; a storage device that stores a plurality of the consumption/emission amounts notified from the notifying unit; and an analysis unit that extracts the step corresponding to the consumption/emission amount that is equal to or greater than a first threshold by analyzing a plurality of the consumption/emission amounts stored in the storage device. Information determining the configuration of data to be measured or a method of measuring the data in a changeable manner is defined as a profile. The measuring unit sets a measurement unit of the consumption/emission amount or a method of measuring the consumption/emission amount on the basis of the profile.

### Effects of the Invention

According to at least the first aspect of the technique disclosed in the present description, a step of a large consumption/emission amount is extracted. This makes it possible to reduce a frequency of analysis on a step of a relatively small consumption/emission amount. This reduces the volume of information to be analyzed, thereby allowing a step of a relatively large consumption/emission amount to be identified efficiently.

These and other objects, features, aspects and advantages of the technique disclosed in the present description will become more apparent from the following detailed description and the accompanying drawings.

### BRIEF DESCRIPTION OF DRAWINGS

FIG. 1 is a view showing an example of an entire configuration of an environmental indicator improvement system according to an embodiment;

FIG. 2 is a view showing an example of data (information) in a profile according to an embodiment;

FIG. 3 is a view showing an example of information about a consumption/emission amount (consumption/emission amount information) generated by a consumption/emission amount measuring unit according to an embodiment;

FIG. 4 is a view showing an example of data (information) in an entire profile in an environmental data control center according to an embodiment;

FIG. 5 is a view showing an example of information generated by an analysis unit of the environmental data control center according to an embodiment;

FIG. 6 is a view showing an example of information in a profile according to an embodiment;

FIG. 7 is a view showing an example of an entire configuration of an environmental indicator improvement system according to an embodiment;

FIG. 8 is a view showing an example of an entire configuration of an environmental indicator improvement system according to an embodiment;

FIG. 9 is a view showing an example of an entire configuration of an environmental indicator improvement system according to an embodiment;

FIG. 10 is a view schematically illustrating a hardware configuration in a case where an environmental indicator improvement system as an analysis system illustrated in FIG. 1, 7, 8, or 9 is actually operated;

FIG. 11 is a view schematically illustrating a hardware configuration in a case where an environmental indicator improvement system as an analysis system illustrated in FIG. 1, 7, 8, or 9 is actually operated; and

FIG. 12 is a view conceptually showing an example of the configuration (functional unit) of an analysis system according to an embodiment.

### DESCRIPTION OF EMBODIMENTS

An embodiment will be described below by referring to the accompanying drawings. In the following embodiment, particular features and others will be shown for describing a technique. However, these features are shown as examples and all of the features are not always essential for making the embodiment implementable.

The drawings are presented schematically. For the convenience of description, structures are omitted or structures are simplified in the drawings, as appropriate. Correlations in terms of size and position between structures shown in different drawings are not always illustrated correctly but are changeable, as appropriate. In order to facilitate understanding of the substance of the embodiment, a hatch may be added in a drawing that may be a plan view, for example, not a sectional view.

In the description given below, similar components will be given the same sign and illustrated with the same sign in the drawings. These components will be given the same name and are to fulfill the same function. Thus, in some cases, detailed description of these components will be omitted in order to avoid overlap.

In the description given in the present description, unless otherwise stated specifically, “including,” “containing,” or “having” of a component is not an exclusive expression intended to exclude other components.

In the description given in the present description, an ordinal number such as “first” or “second” may be used. However, these terms are used for the convenience for facilitating understanding of the substance of an embodiment and the substance of the embodiment should not be limited to sequential order, etc. that might be defined by these ordinary numbers.

### Conceptual Configuration of Analysis System

FIG. 12 is a view conceptually showing an example of the configuration (functional unit) of an analysis system according to the present embodiment.

As illustrated in FIG. 12, the analysis system includes at least one measuring unit 3001, at least one notifying unit 3002, a storage device 3003, and an analysis unit 3004.

The measuring unit 3001 measures each of the amount of consumed energy and the amount of emitted drainage or exhausted air as a consumption/emission amount in a plurality of steps including procurement of a part to form a target product, manufacture of the target product using the part, carriage of the target product, and selling of the target product.

The notifying unit 3002 notifies a plurality of the consumption/emission amounts measured by the measuring unit 3001. The storage device 3003 stores a plurality of the consumption/emission amounts notified from the notifying unit 3002.

The analysis unit 3004 extracts a step corresponding to a consumption/emission amount that is equal to or greater than a first threshold by analyzing a plurality of the consumption/emission amounts stored in the storage device 3003.

Here, information determining the configuration of data to be measured or a method of measuring the data in a changeable manner is defined as a profile.

The measuring unit 3001 sets a measurement unit of the consumption/emission amount or a method of measuring the consumption/emission amount on the basis of the profile.

Configurations shown by using drawings, etc. in the following embodiments correspond to more specific examples of the configuration in FIG. 12 described above.

### First Embodiment

The following describes an analysis system and an analysis method according to the present embodiment.

### Configuration of Analysis System

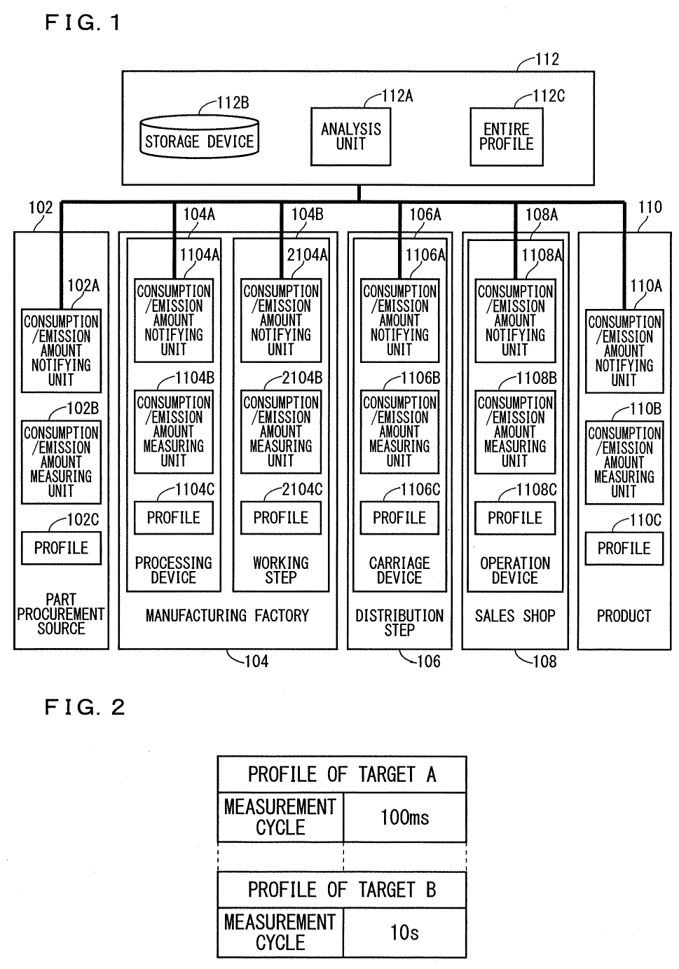

FIG. 1 is a view showing an example of an entire configuration of an environmental indicator improvement system according to the present embodiment. As illustrated in FIG. 1, the environmental indicator improvement system includes a part procurement source 102, a manufacturing factory 104, a distributing step 106, a sales shop 108, a product 110, and an environmental data control center 112.

The product 110 is a precision device, for example. The product 110 is formed by conducting work such as processing or assembly in the manufacturing factory 104 on a plurality of parts procured from the part procurement source 102. The finished product 110 is transferred from the manufacturing factory 104 to the sales shop 108 through the distributing step 106, and is further transferred to a consumer through the distributing step 106.

The part procurement source 102 and the manufacturing factory 104 each consume energy in processing, assembly, and evaluation required for manufacturing parts or the product 110. The distributing step 106 consumes energy in carriage of parts or the product 110. The sales shop 108 consumes energy in selling the product 110 at a retail shop. A consumer consumes energy in using a product.

The part procurement source 102 to procure parts of a target product includes a consumption/emission amount notifying unit 102A and a consumption/emission amount measuring unit 102B, and has a data corresponding to a profile 102C.

The manufacturing factory 104 to manufacture a target product using a part includes a processing device 104A and a working step 104B. The processing device 104A includes a consumption/emission amount notifying unit 1104A and a consumption/emission amount measuring unit 1104B, and has data corresponding to a profile 1104C. The working step 104B includes a consumption/emission amount notifying unit 2104A and a consumption/emission amount measuring unit 2104B, and has data corresponding to a profile 2104C.

The distributing step 106 for carrying a target product includes a carriage device 106A. The carriage device 106A includes a consumption/emission amount notifying unit 1106A and a consumption/emission amount measuring unit 1106B, and has data corresponding to a profile 1106C.

The sales shop 108 to sell a target product includes an operation device 108A. The operation device 108A includes a consumption/emission amount notifying unit 1108A and a consumption/emission amount measuring unit 1108B, and has data corresponding to a profile 1108C.

The product 110 includes a consumption/emission amount notifying unit 110A and a consumption/emission amount measuring unit 110B, and has data corresponding to a profile 110C.

The environmental data control center 112 includes an analysis unit 112A and a storage device 112B, and has data corresponding to an entire profile 112C.

FIG. 2 is a view showing an example of data (information) in a profile according to the present embodiment. As shown in FIG. 1, the profile is provided for each target (step) to consume energy.

As illustrated in FIG. 2, the profile about each target (step) contains measurement unit information about energy such as a measurement cycle. The measurement unit information contains the configuration of data to be measured, a method of measuring data, etc. and others in addition to the measurement cycle, for example. By using the profile (profile 102C, profile 1104C, profile 2104C, profile 1106C, profile 1108C, profile 110C), it is possible to set a trigger for measuring energy.

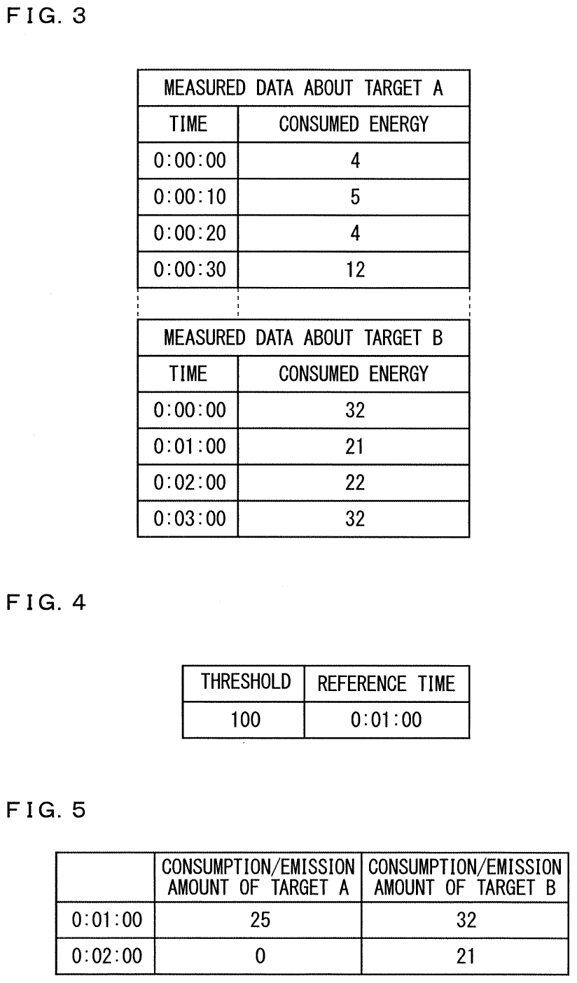

FIG. 3 is a view showing an example of information about a consumption/emission amount (consumption/emission amount information) generated by the consumption/emission amount measuring unit according to the present embodiment. The consumption/emission amount mentioned herein is an amount including at least one of the amount of electric power (energy) consumed by a target product itself, the amount of air exhausted by the target product itself, the amount of electric power (energy) consumed by a target step, the amount of combustion by the target step, the amount of drainage by the target step, and the amount of air exhausted by the target step. In FIG. 3, the amount of electric power consumed by the target product (consumed energy) is shown as an example of the consumption/emission amount together with passage of time.

On the basis of triggers set using the measurement unit information in the profile, the consumption/emission amount measuring unit (consumption/emission amount measuring unit 102B, consumption/emission amount measuring unit 1104B, consumption/emission amount measuring unit 2104B, consumption/emission amount measuring unit 1106B, consumption/emission amount measuring unit 1108B, consumption/emission amount measuring unit 110B) measures a consumption/emission amount that is consumed between a previous trigger and a current trigger, for example, with respect to each item or each order of a target product, and also records the measured consumption/emission amount. One consumption/emission amount measuring unit is provided in response to each step. Meanwhile, if the consumption/emission amount measuring unit is not responsive to the number of steps, one consumption/emission amount measuring unit may be provided in response to all steps, for example.

The consumption/emission amount notifying unit (consumption/emission amount notifying unit 102A, consumption/emission amount notifying unit 1104A, consumption/emission amount notifying unit 2104A, consumption/emission amount notifying unit 1106A, consumption/emission amount notifying unit 1108A, consumption/emission amount notifying unit 110A) notifies the environmental data control center 112 of the consumption/emission amount recorded by the consumption/emission amount measuring unit. The consumption/emission amount notifying unit may notify consumption/emission amounts together recorded several times to the environmental data control center 112. One consumption/emission amount notifying unit is provided in response to each step. Meanwhile, if the consumption/emission amount notifying unit is not responsive to the number of steps, one consumption/emission amount notifying unit may be provided in response to all steps, for example.

The environmental data control center 112 stores consumption/emission amounts collectively into the storage device 112B that are notified from the corresponding consumption/emission amount notifying units (consumption/emission amount notifying unit 102A, consumption/emission amount notifying unit 1104A, consumption/emission amount notifying unit 2104A, consumption/emission amount notifying unit 1106A, consumption/emission amount notifying unit 1108A, consumption/emission amount notifying unit 110A).

FIG. 4 is a view showing an example of data (information) in the entire profile 112C in the environmental data control center 112 according to the present embodiment. As illustrated in FIG. 4, the entire profile 112C contains information about reference time and information about a threshold for a consumption/emission amount.

FIG. 5 is a view showing an example of information generated by the analysis unit 112A of the environmental data control center 112 according to the present embodiment. The analysis unit 112A analyzes data (consumption/emission amount) about each of target steps according to the same standard in each measurement cycle based on the reference time in the entire profile 112C, and extracts a target step where a consumption/emission amount has become equal to or greater than a threshold defined in the entire profile 112C.

The illustration in FIG. 5 shows a consumption/emission amount in each of a target A and a target B measured in each measurement cycle based on the reference time.

In this configuration, it is possible to reduce a frequency of analysis on a step (measurement target) of a relatively small consumption/emission amount. This reduces the volume of information to be analyzed, thereby allowing a step (measurement target) of a relatively large consumption/emission amount, specifically, a step such as a bottleneck step to be identified efficiently. Then, with a focus on data (consumption/emission amount) about a measurement target of a large consumption/emission amount, it is possible to identify a cause for the increase in the consumption/emission amount.

### Second Embodiment

The following describes an analysis system and an analysis method according to the present embodiment. A component corresponding to the component shown in the above-described embodiment will be given the same sign in the following description and shown in the drawings with the same sign, and detailed description thereof will be omitted, as appropriate.

### Configuration of Analysis System

Information in a profile is also available for use in processing each piece of measured data. For example, assuming that consumption/emission amount information is obtained by recording a consumption/emission amount in units of 10 ms in a target step while a measurement cycle in a corresponding profile is 100 ms, ten consumption/emission amounts recorded in units of 10 ms may be added and handled as a consumption/emission amount in units of 100 ms, and may be defined as consumption/emission amount information about the consumption/emission amount in units of 100 ms.

In this configuration, it is possible to calculate a consumption/emission amount by handling pieces of consumption/emission amount information in different measurement cycles collectively on the basis of the same unit (same measurement cycle).

### Third Embodiment

The following describes an analysis system and an analysis method according to the present embodiment. A component corresponding to the component shown in the above-described embodiment will be given the same sign in the following description and shown in the drawings with the same sign, and detailed description thereof will be omitted, as appropriate.

### Configuration of Analysis System

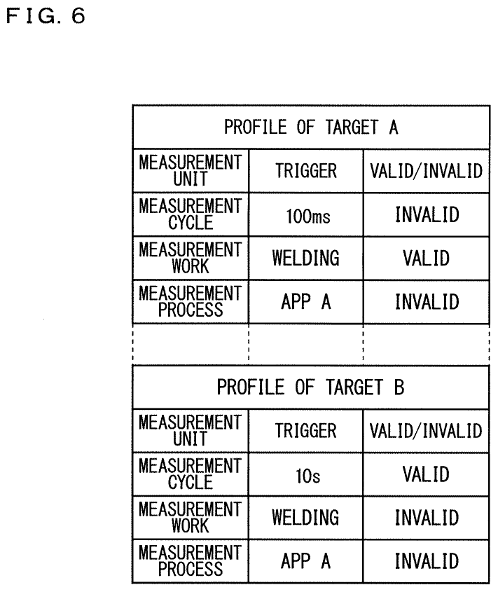

FIG. 6 is a view showing an example of information in a profile according to the present embodiment. As illustrated in FIG. 6, a profile about each target step contains measurement unit information such as measurement work and measurement process in addition to a measurement cycle. A trigger for making measurement, and validity and invalidity of measurement can be set for each piece of measurement unit information.

The measurement work of the measurement unit information defines a lot or work such as transport, and is used for acquiring a consumption/emission amount and required time from start of work to finish of the work.

The measurement process of the measurement unit information is used for acquiring a consumption/emission amount and required time from start of execution to finish of execution of software. The period of time from the start of execution to the finish of execution of the software is stored in a time field in consumption/emission amount information such as that shown in FIG. 3. The consumption/emission amount is stored in a consumed energy field in the consumption/emission amount information.

In this configuration, even if a target of measurement changes, it is still possible to measure a consumption/emission amount properly with respect to each of target products or parts different in terms of measurement work or measurement process.

### Fourth Embodiment

The following describes an analysis system and an analysis method according to the present embodiment. A component corresponding to the component shown in the above-described embodiment will be given the same sign in the following description and shown in the drawings with the same sign, and detailed description thereof will be omitted, as appropriate.

### Configuration of Analysis System

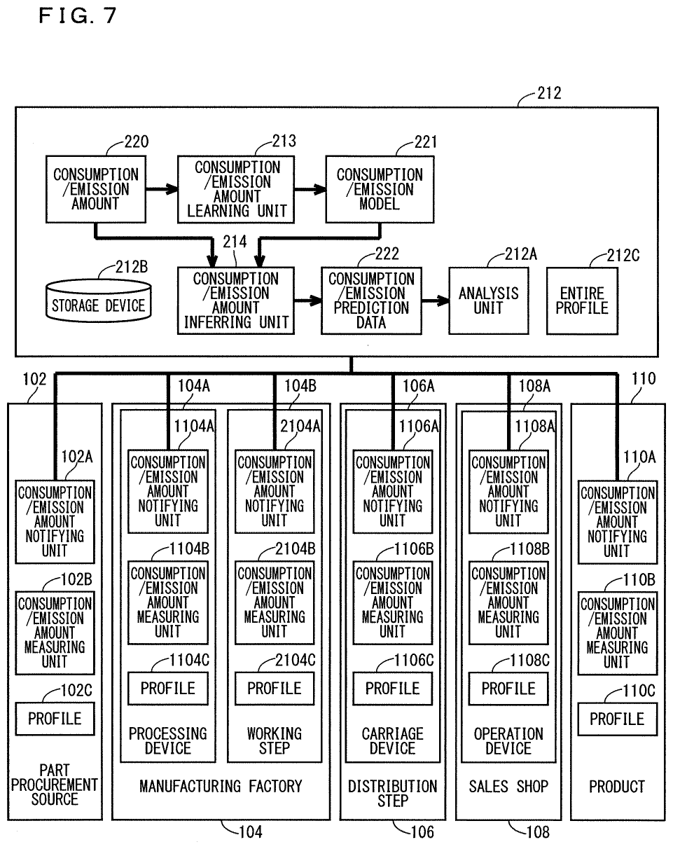

FIG. 7 is a view showing an example of an entire configuration of an environmental indicator improvement system according to the present embodiment. As illustrated in FIG. 7, the environmental indicator improvement system includes a part procurement source 102, a manufacturing factory 104, a distributing step 106, a sales shop 108, a product 110, and an environmental data control center 212.

The environmental data control center 212 includes an analysis unit 212A, a storage device 212B, a consumption/emission amount learning unit 213, and a consumption/emission amount inferring unit 214.

The analysis unit 212A assembles data (consumption/emission amounts) about target steps according to the same standard in each measurement cycle based on reference time defined in an entire profile 212C, and extracts a target step where a consumption/emission amount has become equal to or greater than a threshold defined in the entire profile 212C.

The storage device 212B stores consumption/emission amounts notified from the corresponding consumption/emission amount notifying units (consumption/emission amount notifying unit 102A, consumption/emission amount notifying unit 1104A, consumption/emission amount notifying unit 2104A, consumption/emission amount notifying unit 1106A, consumption/emission amount notifying unit 1108A, consumption/emission amount notifying unit 110A).

The consumption/emission amount learning unit 213 performs machine learning on the basis of a consumption/emission amount 220 stored in the storage device 212B and generates a consumption/emission model 221 for making an inference.

The consumption/emission amount inferring unit 214 outputs consumption/emission prediction data 222 corresponding to a predicted value of a consumption/emission amount in the future on the basis of the consumption/emission model 221 and the consumption/emission amount 220.

In the environmental data control center 212, the consumption/emission amount inferring unit 214 outputs the consumption/emission prediction data 222 corresponding to a predicted value of a consumption/emission amount in the future on the basis of the consumption/emission model 221 and the consumption/emission amount 220.

Then, the analysis unit 212A extracts a target (step) where a consumption/emission amount in the future is to become equal to or greater than a threshold on the basis of an emission amount having been acquired so far and the consumption/emission prediction data 222 corresponding to the predicted value of the consumption/emission amount in the future.

In this configuration, it is possible to infer a target (step) where a consumption/emission amount is to increase in the future.

### Fifth Embodiment

The following describes an analysis system and an analysis method according to the present embodiment. A component corresponding to the component shown in the above-described embodiment will be given the same sign in the following description and shown in the drawings with the same sign, and detailed description thereof will be omitted, as appropriate.

### Configuration of Analysis System

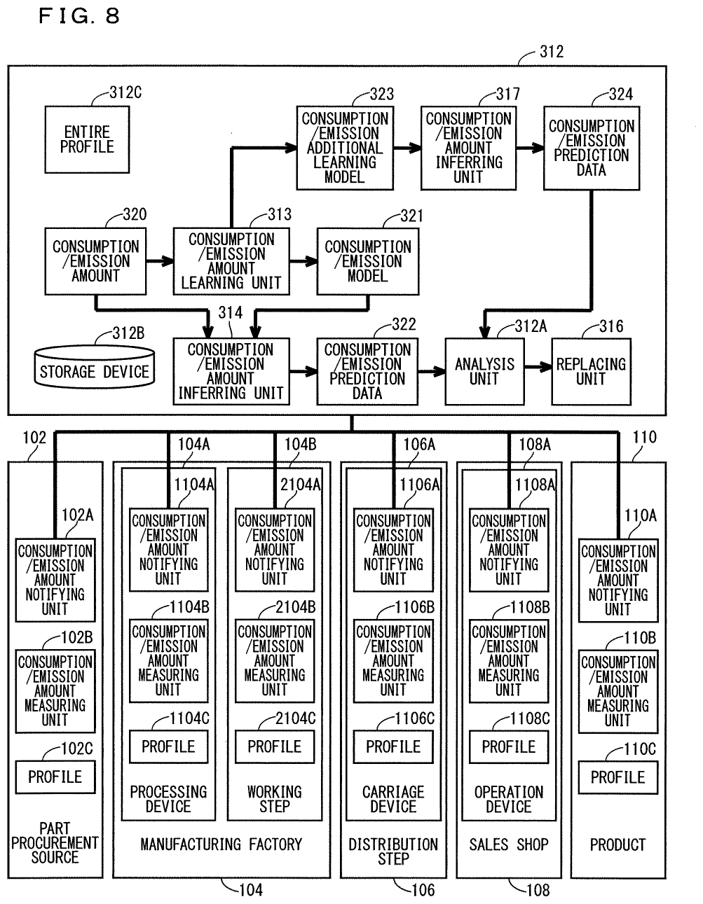

FIG. 8 is a view showing an example of an entire configuration of an environmental indicator improvement system according to the present embodiment. As illustrated in FIG. 8, the environmental indicator improvement system includes a part procurement source 102, a manufacturing factory 104, a distributing step 106, a sales shop 108, a product 110, and an environmental data control center 312.

The environmental data control center 312 includes an analysis unit 312A, a storage device 312B, a consumption/emission amount learning unit 313, a consumption/emission amount inferring unit 314, a replacing unit 316, and a consumption/emission amount inferring unit 317.

The analysis unit 312A assembles data (consumption/emission amounts) about target steps according to the same standard in each measurement cycle based on reference time defined in an entire profile 312C, and extracts a target step where a consumption/emission amount has become equal to or greater than a threshold defined in the entire profile 312C.

The storage device 312B stores consumption/emission amounts notified from the corresponding consumption/emission amount notifying units (consumption/emission amount notifying unit 102A, consumption/emission amount notifying unit 1104A, consumption/emission amount notifying unit 2104A, consumption/emission amount notifying unit 1106A, consumption/emission amount notifying unit 1108A, consumption/emission amount notifying unit 110A).

The consumption/emission amount learning unit 313 performs machine learning on the basis of a consumption/emission amount 320 stored in the storage device 312B and generates a consumption/emission model 321 for making an inference.

The consumption/emission amount learning unit 313 further performs additional learning on the basis of the consumption/emission amount 320 stored in the storage device 312B and generates a consumption/emission additional learning model 323 for making an inference.

The consumption/emission amount inferring unit 314 outputs consumption/emission prediction data 322 corresponding to a predicted value of a consumption/emission amount in the future on the basis of the consumption/emission model 321 and the consumption/emission amount 320.

The consumption/emission amount inferring unit 317 outputs consumption/emission prediction data 324 corresponding to a predicted value of a consumption/emission amount in the future on the basis of the consumption/emission additional learning model 323. The consumption/emission amount inferring unit 317 can be the same as the consumption/emission amount inferring unit 314.

The consumption/emission model 321 is generated using the consumption/emission amount 320 stored in the storage device 312B at a particular moment and is not updated until an instruction for relearning is given thereafter.

The consumption/emission additional learning model 323 is result obtained by relearning performed on the basis of the consumption/emission amount 320 in the storage device 312B used in generating the consumption/emission model 321 and additionally, on the basis of the consumption/emission amount 320 added thereafter, is part of the result obtained by relearning performed on the basis of the consumption/emission amount 320 in the storage device 312B used in generating the consumption/emission model 321 and additionally, on the basis of the consumption/emission amount 320 added thereafter, or is result obtained by learning performed on the basis of only the consumption/emission amount 320 added thereafter.

In relation to a particular time period, the analysis unit 312A compares each of the consumption/emission prediction data 322 generated on the basis of the consumption/emission model 321 and the consumption/emission prediction data 324 generated on the basis of the consumption/emission additional learning model 323 with an actual value in the time period. Then, the analysis unit 312A compares a difference between a predicted value of a consumption/emission amount based on the consumption/emission prediction data 322 and the actual value with a difference between a predicted value of a consumption/emission amount based on the consumption/emission prediction data 324 and the actual value, and selects the consumption/emission prediction data of the smaller difference.

If the consumption/emission prediction data selected by the analysis unit 312A has been generated on the basis of the consumption/emission additional learning model 323, the replacing unit 316 replaces the consumption/emission model 321 with the consumption/emission additional learning model 323.

In this configuration, it is possible to infer a target step of a large consumption/emission while updating the amount with high accuracy consumption/emission model 321 on the basis of actual achievement.

### Sixth Embodiment

The following describes an analysis system and an analysis method according to the present embodiment. A component corresponding to the component shown in the above-described embodiment will be given the same sign in the following description and shown in the drawings with the same sign, and detailed description thereof will be omitted, as appropriate.

### Configuration of Analysis System

The configuration of an environmental indicator improvement system can be determined by adding an update necessity notifying unit and a profile updating unit to the embodiments from the first embodiment to the fifth embodiment descried above.

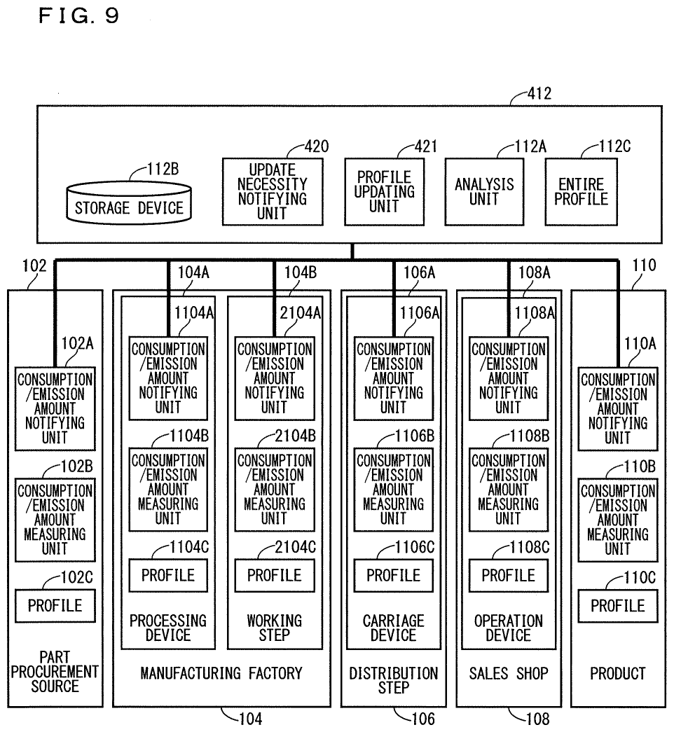

FIG. 9 is a view showing an example of an entire configuration of the environmental indicator improvement system according to the present embodiment. As illustrated in FIG. 9, the environmental indicator improvement system includes a part procurement source 102, a manufacturing factory 104, a distributing step 106, a sales shop 108, a product 110, and an environmental data control center 412.

The environmental data control center 412 includes an analysis unit 112A, a storage device 112B, an update necessity notifying unit 420, and a profile updating unit 421, and has data corresponding to an entire profile 112C.

In FIG. 9, the update necessity notifying unit 420 and the profile updating unit 421 are shown as components of the environmental data control center 412. Alternatively, the update necessity notifying unit 420 and the profile updating unit 421 may be added as components of a measurement target. Still alternatively, only one of the update necessity notifying unit 420 and the profile updating unit 421 may be a component of the environmental data control center 412, and the other may be a component may be a component of a measurement target.

The update necessity notifying unit 420 has a setting condition with respect to each measurement target set by a data user in response to a purpose, and, on the basis of the setting condition, makes a judgment on time-series change in a consumption/emission amount of a measurement target. Then, the update necessity notifying unit 420 notifies the profile updating unit 421 of the necessity of updating a profile.

The above setting condition is a condition of being equal to or greater than a threshold for a consumption/emission amount permitted by a data user, or is a condition that a rate of change per day or per unit time in a consumption/emission amount permitted by a data user is equal to or greater than a threshold, for example. In other cases, the setting condition may be set by combining a generally-employed analysis technique relating to time-series data to establish a condition that a value obtained by performing the four fundamental operations or performing differential and integral calculus once or more on a consumption/emission amount falls within a certain range or a condition that change different from time-series change in the past has been observed using result of machine learning, for example.

A judgment based on the above setting condition is made by the update necessity notifying unit 420 in each measurement cycle. The update necessity notifying unit 420 determines whether time-series change in a consumption/emission amount of a measurement target has changed from a state of fulfilling the setting condition to a state of not fulfilling the setting condition, or determines whether the time-series change in a consumption/emission amount of the measurement target has changed from the state of not fulfilling the setting condition to the state of fulfilling the setting condition.

If the time-series change in a consumption/emission amount of the measurement target has changed from the state of fulfilling the setting condition to the state of not fulfilling the setting condition, the update necessity notifying unit 420 notifies the profile updating unit 421 to shorten a measurement cycle for measuring a consumption/emission amount.

Conversely, if the time-series change in a consumption/emission amount of the measurement target has changed from the state of not fulfilling the setting condition to the state of fulfilling the setting condition, the update necessity notifying unit 420 notifies the profile updating unit 421 to extend a measurement cycle for measuring a consumption/emission amount.

The profile updating unit 421 updates a content in a profile set for the measurement target in response to the notification from the update necessity notifying unit 420.

If the profile updating unit 421 is notified to shorten or extend the measurement cycle, the profile updating unit 421 shortens or extends the measurement cycle by following a rule defined in advance.

The rule for shortening the measurement cycle may be defined in terms of a ratio so as to multiply a data volume by ten times, and may be defined so as to provide a maximum collectable data volume by considering the capacity of a measuring device to collect data and the volume of communication with the environmental data control center, for example.

The rule for extending the measurement cycle may be defined in terms of a ratio so as to multiply a data volume by one-tenth, or may be defined so as to restore a value at the start of running, for example.

The setting condition owned by the update necessity notifying unit 420 may be two or more conditions set for one measurement target. In this case, the above judgment is made under each of the setting conditions and result of the judgment is notified to the profile updating unit 421.

The profile updating unit 421 has a rule for changing a measurement cycle under each setting condition. In response to the notification from the update necessity notifying unit 420, the profile updating unit 421 changes a profile on the basis of a corresponding rule.

According to the present embodiment, it is possible to detect a situation where a target or an environment of production has changed and a consumption/emission amount of a measurement target has changed to a level equal to or greater than a range of permission by a data user. It is also possible to change a profile dynamically in response to the detected situation so as to measure detailed data about a consumption/emission amount of the measurement target.

By doing so, it becomes possible to identify a cause for the change in a consumption/emission amount. This eventually makes it possible to contribute to activity for improvement so as to achieve a consumption/emission amount permitted by the data user.

### Hardware Configuration of Analysis System

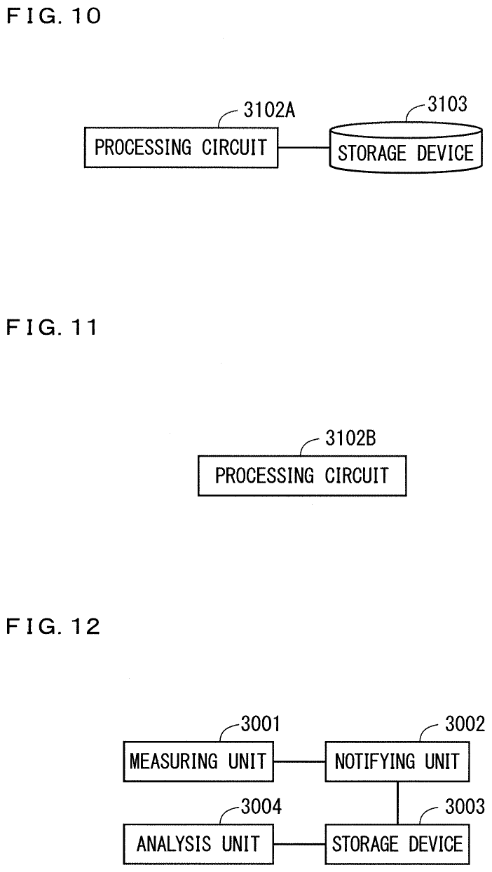

FIGS. 10 and 11 are views each schematically illustrating a hardware configuration in a case where an environmental indicator improvement system as an analysis system illustrated in FIG. 1, 7, 8, or 9 is actually operated.

The hardware configuration illustrated in each of FIGS. 10 and 11 may not conform in terms of number, etc. to the configuration illustrated in FIG. 1, 7, 8, or 9. This is for the reason that the configurations illustrated in FIGS. 1, 7, 8, and 9 show conceptual units.

Thus, there are at least assumable cases as follows: one of the configurations illustrated in FIGS. 1, 7, 8, and 9 is composed of a plurality of hardware configurations illustrated in FIGS. 10 and 11, one of the configurations illustrated in FIGS. 1, 7, 8, and 9 corresponds to a part of the hardware configurations illustrated in FIGS. 10 and 11, and two or more of the configurations illustrated in FIGS. 1, 7, 8, and 9 are provided in one of the hardware configurations illustrated in FIGS. 10 and 11.

FIG. 10 shows a processing circuit 3102A for performing calculation and a storage device 3103 capable of storing information that function as hardware configurations for realizing the consumption/emission amount measuring unit, the analysis unit, the consumption/emission amount learning unit, the consumption/emission amount inferring unit, the replacing unit, etc. shown in FIG. 1, 7, 8, or 9. These configurations are applicable to any of the above-described embodiments.

FIG. 11 shows a processing circuit 3102B for performing calculation that functions as a hardware configuration for realizing the consumption/emission amount measuring unit, the analysis unit, the consumption/emission amount learning unit, the consumption/emission amount inferring unit, the replacing unit, the storage device, etc. shown in FIG. 1, 7, 8, or 9. This configuration is applicable to any of the above-described embodiments.

The storage device 112B (or storage device 212B, storage device 312B) is realized by the storage device 3103 or by a different storage device (not illustrated in the present drawings).

The storage device 3103 is a memory (recording medium) including a volatile or nonvolatile semiconductor memory such as a hard disk drive (namely, HDD), a random access memory (namely, RAM), a read-only memory (namely, ROM), a flash memory, an erasable programmable read-only memory (EPROM), or an electrically erasable programmable read-only memory (EEPROM), a magnetic disk, a flexible disk, an optical disk, a compact disk, a minidisk, or a DVD, or any type of recording medium to be used in the future, for example,

The processing circuit 3102A may be a circuit to execute a program stored in the storage device 3103, an external CD-ROM, an external DVD-ROM, or an external flash memory, for example. Specifically, the processing circuit 3102A may be a central processing unit (namely, CPU), a microprocessor, a microcomputer, or a digital signal processor (namely, DSP), for example.

If the processing circuit 3102A is to execute a program stored in the storage device 3103, an external CD-ROM, an external DVD-ROM, or an external flash memory, the consumption/emission amount measuring unit, the analysis unit, the consumption/emission amount learning unit, the consumption/emission amount inferring unit, and the replacing unit are realized by software, firmware, or a combination of software and firmware resulting from execution of the program in the storage device 3103 by the processing circuit 3102A. The functions of the consumption/emission amount measuring unit, the analysis unit, the consumption/emission amount learning unit, the consumption/emission amount inferring unit, and the replacing unit may be realized by causing a plurality of processing circuits to work in cooperation with each other.

Software and firmware may be described as programs and may be stored in the storage device 3103. In this case, the processing circuit 3102A realizes the above-described functions by reading the programs from the storage device 3103 and executing the read programs. Specifically, the storage device 3103 may be a device to store a program to eventually result in implementation of the above-described functions by being executed by the processing circuit 3102A.

The processing circuit 3102B may be dedicated hardware. Specifically, the processing circuit 3102B may be a single circuit, a complex circuit, a programmed processor, a parallel-programmed processor, an integrated circuit (application-specific integrated circuit, namely, ASIC), a field-programmable gate array (FPGA), or a combination thereof, for example.

If the processing circuit 3102B is dedicated hardware, the consumption/emission amount measuring unit, the analysis unit, the consumption/emission amount learning unit, the consumption/emission amount inferring unit, and the replacing unit are realized by causing the processing circuit 3102B to run. The functions of the consumption/emission amount measuring unit, the analysis unit, the consumption/emission amount learning unit, the consumption/emission amount inferring unit, and the replacing unit may be realized by respective circuits or by a single circuit.

Some of the functions of the consumption/emission amount measuring unit, the analysis unit, the consumption/emission amount learning unit, the consumption/emission amount inferring unit, and the replacing unit may be realized by the processing circuit 3102A to execute a program stored in the storage device 3103, and some of these functions may be realized by the processing circuit 3102B as dedicated hardware.

### Effects Achieved by Plurality of Above-Described Embodiments

Exemplary effects achieved by the above-described plurality of embodiments will be described next. These effects will be described in the following on the basis of the exemplary specific configurations shown in the above-described plurality of embodiments. These configurations are replaceable with other exemplary specific configurations shown in the present description within a range in which comparable effects are achieved. Specifically, while only one of the associated specific configurations will be shown as a representative for the sake of convenience, this configuration shown as a representative is replaceable with a different one of the associated specific configurations.

This replacement may be made across two or more of the embodiments. Specifically, comparable effects may be achieved by combining exemplary configurations shown in the respective embodiments.

According to the above-described embodiments, the analysis system includes at least one measuring unit, at least one notifying unit, the storage device 112B (or storage device 212B, storage device 312B), and the analysis unit 112A (or analysis unit 212A, analysis unit 312A). The measuring unit corresponds to at least one of the consumption/emission amount measuring unit 102B, the consumption/emission amount measuring unit 110B, the consumption/emission amount measuring unit 1104B, the consumption/emission amount measuring unit 1106B, the consumption/emission amount measuring unit 1108B, the consumption/emission amount measuring unit 2104B, and others, for example. The notifying unit corresponds to at least one of the consumption/emission amount notifying unit 102A, the consumption/emission amount notifying unit 110A, the consumption/emission amount notifying unit 1104A, the consumption/emission amount notifying unit 1106A, the consumption/emission amount notifying unit 1108A, the consumption/emission amount notifying unit 2104A, and others, for example. The consumption/emission amount measuring unit 102B measures each of the amount of consumed energy and the amount of emitted drainage or exhausted air as the consumption/emission amount 220 (or consumption/emission amount 320) in a plurality of steps including procurement of a part to form a target product, manufacture of the target product using the part, carriage of the target product, and selling of the target product. The consumption/emission amount notifying unit 102A notifies a plurality of the consumption/emission amounts 220 measured by the consumption/emission amount measuring unit 102B. The storage device 112B stores a plurality of the consumption/emission amounts 220 notified from the consumption/emission amount notifying unit 102A. The analysis unit 112A extracts a step corresponding to the consumption/emission amount 220 that is equal to or greater than a first threshold by analyzing a plurality of the consumption/emission amounts 220 stored in the storage device 112B. Here, information determining the configuration of data to be measured or a method of measuring the data in a changeable manner is defined as the profile 102C (or profile 110C, profile 1104C, profile 2104C, profile 1106C, or profile 1108C). The consumption/emission amount measuring unit 102B sets a measurement unit of the consumption/emission amount 220 or a method of measuring the consumption/emission amount 220 on the basis of the profile 102C.

According to the above-described embodiments, the analysis system includes the processing circuit 3102A that executes a program, and the storage device 3103 storing the program to be executed. Execution of the program by the processing circuit 3102A realizes the following operations.

Specifically, each of the amount of consumed energy and the amount of emitted drainage or exhausted air is measured as the consumption/emission amount 220 in a plurality of steps including procurement of a part to form a target product, manufacture of the target product using the part, carriage of the target product, and selling of the target product. A plurality of the measured consumption/emission amounts 220 is notified. A plurality of the notified consumption/emission amounts 220 is stored. A step corresponding to the consumption/emission amount 220 that is equal to or greater than a first threshold is extracted by analyzing a plurality of the stored consumption/emission amounts 220. Here, information determining the configuration of data to be measured or a method of measuring the data in a changeable manner is defined as the profile 102C. In measuring the consumption/emission amount 220, a measurement unit of the consumption/emission amount 220 or a method of measuring the consumption/emission amount 220 is set on the basis of the profile 102C.

According to the above-described embodiments, the analysis system includes the processing circuit 3102B as dedicated hardware. The processing circuit 3102B as dedicated hardware performs the following operations.

Specifically, the processing circuit 3102B as dedicated hardware measures each of the amount of consumed energy and the amount of emitted drainage or exhausted air as the consumption/emission amount 220 in a plurality of steps including procurement of a part to form a target product, manufacture of the target product using the part, carriage of the target product, and selling of the target product. The processing circuit 3102B notifies a plurality of the measured consumption/emission amounts 220. The processing circuit 3102B stores a plurality of the notified consumption/emission amounts 220. The processing circuit 3102B extracts a step corresponding to the consumption/emission amount 220 that is equal to or greater than a first threshold by analyzing a plurality of the stored consumption/emission amounts 220. Here, information determining the configuration of data to be measured or a method of measuring the data in a changeable manner is defined as the profile 102C. In measuring the consumption/emission amount 220, the processing circuit 3102B sets a measurement unit of the consumption/emission amount 220 or a method of measuring the consumption/emission amount 220 on the basis of the profile 102C.

In this configuration, a step of a large consumption/emission amount is extracted. This makes it possible to reduce a frequency of analysis on a step (measurement target) of a relatively small consumption/emission amount. This reduces the volume of information to be analyzed, thereby allowing a step (measurement target) of a relatively large consumption/emission amount, specifically, a step such as a bottleneck step to be identified efficiently. Then, with a focus on data (consumption/emission amount) about a measurement target of a large consumption/emission amount, it is possible to identify a cause for the increase in the consumption/emission amount.

Comparable effects can also be achieved in a case where other exemplary configurations shown in the present description are added appropriately to the above configurations, namely, in a case where other configurations shown in the present description but not referred to as the above configurations are added appropriately.

According to the above-described embodiments, the consumed energy as a measurement target includes energy consumed by the target product itself. In this configuration, it is possible to extract a step of a large consumption/emission amount that includes the energy consumed by the target product during the step.

According to the above-described embodiments, each of the consumption/emission amount measuring unit and the consumption/emission amount notifying unit is provided in response to each of a plurality of the steps. The storage device 112B stores a plurality of the consumption/emission amounts collectively that are notified from a plurality of the consumption/emission amount notifying units. This configuration allows the environmental data control center to control the consumption/emission amounts collectively that are measured by the corresponding measuring units, and to easily make a comparison between the consumption/emission amounts of the corresponding steps.

According to the above-described embodiments, the consumption/emission amount measuring unit 102B measures the consumption/emission amount 220 with respect to each item or each order of the target product. In this configuration, if a target of production changes, it is possible to identify a cause for a large consumption/emission amount with respect to each part (item, order) of a product to be formed.

According to the above-described embodiments, the analysis system includes a learning unit that performs machine learning using the consumption/emission amount 220 (or consumption/emission amount 320) and generates a first consumption/emission model (or consumption/emission model 221, consumption/emission model 321, for example), and a first inferring unit that generates first prediction data (consumption/emission prediction data 222 or consumption/emission prediction data 322, for example) that is data about a predicted amount of the consumption/emission amount 220 on the basis of the consumption/emission model 221. Here, the learning unit corresponds to at least one of the consumption/emission amount learning unit 213, the consumption/emission amount learning unit 313, and others, for example. The first inferring unit corresponds to at least one of the consumption/emission amount inferring unit 214, the consumption/emission amount inferring unit 314, and others, for example. The analysis unit 212A extracts a step corresponding to the consumption/emission amount 220 that is equal to or greater than the first threshold by analyzing the predicted amount of the consumption/emission amount 220 based on the consumption/emission prediction data 222. In this configuration, it is possible to infer a target (step) where a consumption/emission amount is to increase in the future.

According to the above-described embodiments, in the analysis system, the consumption/emission amount learning unit 313 performs additional learning using the consumption/emission amount 320 and generates a second consumption/emission model (consumption/emission additional learning model 323, for example). The analysis system includes a second inferring unit that generates second prediction data (consumption/emission prediction data 324, for example) that is data about a predicted amount of the consumption/emission amount 320 on the basis of the consumption/emission additional learning model 323. Here, the second inferring unit corresponds to the consumption/emission amount inferring unit 317 and others, for example. The analysis unit 312A extracts a step corresponding to the consumption/emission amount 320 that is equal to or greater than the first threshold by selecting and analyzing the consumption/emission prediction data 322 or the consumption/emission prediction data 324 relating to a particular time period. The selected and analyzed consumption/emission prediction data represents a predicted amount of the consumption/emission amount 320 having a smaller difference from an actual value corresponding to the time period. In this configuration, several pieces of prediction data are generated through the additional learning and one piece of prediction data is selected therefrom to improve the accuracy of the prediction data, making it possible to infer a target step of a large consumption/emission amount with high accuracy.

According to the above-described embodiments, the analysis system includes the replacing unit 316 that replaces the consumption/emission model 321 with the consumption/emission additional learning model 323 if the analysis unit 312A selects the consumption/emission prediction data 324. In this configuration, it is possible to infer a target step of a large consumption/emission amount with high accuracy while updating the consumption/emission model 321 on the basis of actual achievement.

According to the above-described embodiments, the analysis system includes an updating unit that updates the profile 102C if time-series change in the consumption/emission amount 220 is equal to or greater than a second threshold. Here, the updating unit corresponds to the profile updating unit 421 and others, for example. In this configuration, if a target or an environment of production changes to change a cause for a bottleneck, it is possible to identify a step of a large consumption/emission amount by updating the profile dynamically.

According to the above-described embodiments, in an analysis method, each of the amount of consumed energy and the amount of emitted drainage or exhausted air is measured as the consumption/emission amount 220 in a plurality of steps including procurement of a part to form a target product, manufacture of the target product using the part, carriage of the target product, and selling of the target product. A plurality of the measured consumption/emission amounts 220 is notified. A plurality of the notified consumption/emission amounts 220 is stored. A step corresponding to the consumption/emission amount 220 that is equal to or greater than a first threshold is extracted by analyzing a plurality of the stored consumption/emission amounts 220. Here, information determining the configuration of data to be measured or a method of measuring the data in a changeable manner is defined as the profile 102C. In measuring the consumption/emission amount 220, a measurement unit of the consumption/emission amount 220 or a method of measuring the consumption/emission amount 220 is set on the basis of the profile 102C.

In this configuration, a step of a large consumption/emission amount is extracted. This makes it possible to reduce a frequency of analysis on a step (measurement target) of a relatively small consumption/emission amount. This reduces the volume of information to be analyzed, thereby allowing a step (measurement target) of a relatively large consumption/emission amount, specifically, a step such as a bottleneck step to be identified efficiently. Then, with a focus on data (consumption/emission amount) about a measurement target of a large consumption/emission amount, it is possible to identify a cause for the increase in the consumption/emission amount.

Unless there is a particular limitation, sequential order in which the processes are performed is changeable.

Comparable effects can also be achieved in a case where other exemplary configurations shown in the present description are added appropriately to the above configurations, namely, in a case where other configurations shown in the present description but not referred to as the above configurations are added appropriately.

### Modifications of Plurality of Above-Described Embodiments

In a plurality of the above-described embodiment, in some cases, each component is further described in terms of a quality of material, a raw material, a dimension, a shape, a relative location, or a condition for implementation, for example. However, these are given as examples in all aspects and are not to be regarded as restrictive.

Thus, numerous unillustrated modifications and equivalents are assumable within the scope of the technique disclosed in the present description. The assumable cases include a case where at least one component is modified, added, or omitted, and a case where at least one component is extracted from at least one embodiment and the extracted component is combined with a component in a different embodiment, for example.

Regarding the statement in the above-described embodiments showing that “one” component is provided, this statement means that the number of such components may be “one or more” as long as it causes no inconsistency.

Furthermore, each component shown in the above-described embodiments is a conceptual unit. The scope of the technique disclosed in the present description covers a case where a component is composed of a plurality of structures, a case where one component corresponds to a part of a structure, and a case where a plurality of components is provided to one structure.

Each component shown in the above-described embodiments includes a structure having a different configuration or shape as long as such a structure fulfills the same function.

The statements given in the present description are to be referred to for every purpose relating to the present technique, and should never be regarded as a conventional technique.

Each component shown in the above-described embodiments is assumed as software or firmware, or as hardware corresponding thereto. Each component as software is referred to as a “unit,” and each component as hardware is referred to a “processing circuit” (circuitry), for example.

The technique disclosed in the present description may be applied to a case where components are distributed to a plurality of devices, namely, may be configured as a system as a combination of a plurality of the devices.

### Explanation of Reference Signs

102C Profile, 110 Product, 110C Profile, 112A Analysis unit, 112B Storage device, 212A Analysis unit, 212B Storage device, 220 Consumption/emission amount, 221 Consumption/emission model, 312A Analysis unit, 312B Storage device, 316 Replacing unit, 320 Consumption/emission amount, 321 Consumption/emission model, 1104C Profile, 1106C Profile, 1108C Profile, 2104C Profile, 3001 Measuring unit, 3002 Notifying unit, 3003 Storage device, 3004 Analysis unit, 3103 Storage device

1. An analysis system comprising:
at least one processor to execute a program; and
at least one memory to store the program which, when it is executed by the processor, performs processes of:
measuring at least one of the amount of consumed energy, the amount of emitted drainage, and the amount of exhausted air as a consumption/emission amount in a step including manufacture of a target product; and
extracting the step corresponding to the consumption/emission amount that is equal to or greater than a first threshold by analyzing the consumption/emission amount, wherein
information determining the configuration of data to be measured or a method of measuring the data in a changeable manner is defined as a profile, and
the measuring includes setting a measurement unit of the consumption/emission amount or a method of measuring the consumption/emission amount on the basis of the profile.

2. The analysis system according to claim 1, wherein
the consumed energy includes at least one of the energy consumed by the target product itself or the energy consumed in the step.

3. (canceled)

4. The analysis system according to claim 1, wherein
the measuring includes measuring the consumption/emission amount with respect to each item or each order of the target product.

5. The analysis system according to claim 1, further comprising:
performing machine learning using the consumption/emission amount and generating a first consumption/emission model; and
generating first prediction data that is data about a predicted amount of the consumption/emission amount on the basis of the first consumption/emission model, wherein
the extracting includes extracting the step corresponding to the consumption/emission amount that is equal to or greater than the first threshold by analyzing the predicted amount of the consumption/emission amount based on the first prediction data.

6. The analysis system according to claim 5, wherein
the generating the first consumption/emission model includes performing additional learning using the consumption/emission amount and generating a second consumption/emission model,
the analysis system further comprises:
generating second prediction data that is data about a predicted amount of the consumption/emission amount on the basis of the second consumption/emission model, and
the extracting includes extracting the step corresponding to the consumption/emission amount that is equal to or greater than the first threshold by selecting and analyzing the first prediction data or the second prediction data relating to a particular time period, the selected and analyzed prediction data representing the predicted amount of the consumption/emission amount having a smaller difference from an actual value corresponding to the time period.

7. The analysis system according to claim 6, further comprising:
replacing the first consumption/emission model with the second consumption/emission model if the extracting selects the second prediction data.

8. The analysis system according to claim 1, further comprising:
updating the profile if time-series change in the consumption/emission amount is equal to or greater than a second threshold.

9. An analysis method comprising:
measuring at least one of the amount of consumed energy, the amount of emitted drainage, and the amount of exhausted air as a consumption/emission amount in a step including manufacture of a target product;
extracting the step corresponding to the consumption/emission amount that is equal to or greater than a first threshold by analyzing the consumption/emission amount;
defining information determining the configuration of data to be measured or a method of measuring the data in a changeable manner as a profile; and
in measuring the consumption/emission amount, setting a measurement unit of the consumption/emission amount or a method of measuring the consumption/emission amount on the basis of the profile.
